(19) United States
(12) Patent Application Publication
(10) Pub. No.: US 2004/0250115 A1
(43) Pub. Date: Dec. 9, 2004

(54) Self-contained mechanism for deploying and controlling data security services via a web browser platform

(75) Inventors: James Dal Gemmel, Taipei (TW); Alvin Wang Graylin, Bellevue, WA (US)

Correspondence Address: Ya-Chiao Chang, c/o BAKER & McKENZIE, 29th Floor, 805 Third Avenue, New York, NY, 10022, US

(73) Assignee: Trend Micro Incorporated.

(21) Appl. No.: 10/421,164

(22) Filed: Apr. 21, 2003

(51) Int. Cl. H04L 9/00

(52) U.S. Cl. 713/201

(57) ABSTRACT

The invention generally provides data security network system and method integrated with a browser. A preferred embodiment of the method according to the invention primarily comprises the steps of calling a server having at least a first cabinet file and a second cabinet file from a client computer, directing the first cabinet file to the client computer by the server, displaying a data security control on an Internet browser at the client computer, activating the data security control, redirecting the client computer's browser to a specific web page, popping up the browser with embedded control components producing a scanning dialog box, and scanning the client computer. The network system according to a preferred embodiment of the invention includes a server having at least a first cabinet file and a second cabinet file, a client computer having at least an Internet browser connected with the server, and a data security control on the browser of the client computer wherein the browser is redirected to a specific web page for scanning computer viruses.

### BACKGROUND OF THE INVENTION

1. Field of the Invention

The invention claimed in the present patent application generally relates to a data security system and method, and more particularly, to a data security system and method integrated with a browser platform.

2. Description of the Related Art

The Internet is an ideal mass medium for the spread of computer viruses since virtually every computer needs to be connected to another computer or network either directly or indirectly. The Internet, with all its benefits and fascinations, is nonetheless an effective and efficient medium for an intentional spread of malicious code and hacker attacks. It has been estimated that some fast-paced viruses can spread throughout the entire Internet within a matter of a couple of hours if not effectively stopped (the recent SQL Slammer virus only needed ten minutes to infect 90% of susceptible computers worldwide). For any network environment, be it the Internet, a metropolitan area network (MAN), a wide area network (WAN), a local area network (LAN) or even wireless communications networks for mobile phones and personal digital assistant (PDA) devices, the more data transmitted and the more services offered, the more likely computer viruses are able to infect those networks.

A standard data security practice is deploying data security software programs in the device nodes and servers within the network. The data security programs regularly reside under the operation system, for example, Microsoft Windows™, and scan the stored data within the network for computer viruses at the database level. There are generally three methods in use in the art, including scanning, integrity checking and interception.

The first method in the art is scanning, where computer viruses are detected by matching signatures or characteristics that link new viruses to existing viruses. By its nature, scanning requires that data security service providers and end users keep data security systems up to date. The second method in the art is integrity checking. Integrity checking systems record information about network systems for later comparison with known data patterns and existing data structures in order to detect changes. The third method in the art is interception, where system-level routines are monitored for malign or catastrophic acts. A given data security software program in the art will likely use a combination of the three techniques for maximum possibility of virus detection.

However, with the development of the browser platform, for example Microsoft Explorer™, computer viruses and hackers will have more choices in deciding where to penetrate and reside the network system. Internet browsers are vulnerable to viruses or unwanted spy programs. The viruses could reside in two platforms, i.e., under the operation system or under the browser. Data security systems in the art currently focus detection and prevention efforts on a single platform, namely, the operation system platform.

Thus, shortcomings are inherent in the standard practice of the art. If such computer viruses exist and are only active on the browser platform, conventional data security systems in the art will detect them by crossing through the first platform to the second platform, which is a significant security defect.

In addition to computer virus protection, communication between server and client computers, vulnerability assessment of the client computer and the removal of defunct services on the client computer are also needed. There is thus a general need in the art for a data security method and system with integrated services overcoming at least the aforementioned shortcomings in the art. In particular, there is a need in the art for a cross-platform data security method and system advantageously and optimally operating under the Internet browser and operating system platforms.

### SUMMARY OF THE INVENTION

The invention generally provides a data security network system and method integrated with an Internet browser. A preferred embodiment of the method according to the invention primarily comprises the steps of calling a computer server having at least a first cabinet file and a second cabinet file from a client computer, directing the first cabinet file to the client computer, displaying a data security control on an Internet browser at the client computer, activating the data security control, redirecting the browser at the client computer to a specific web page, popping up the browser with embedded control components producing a scanning dialog box, and scanning the client computer.

The method according to the invention can further include the steps of executing an independent executable file and calling the server through the Internet browser at the client computer. The first cabinet file further comprises at least one dynamic link library (DLL) file, one initialization (INI) file, and one font information (INF) file. The dynamic link library (DLL) file further comprises data security control icons for the browser and Component Object Model (COM) objects. The initialization (INI) file further comprises Uniform Resource Locator (URL) information linking the second cabinet file located on the server. The method according to the invention can further include the steps of the font information (INF) file copying the dynamic link library (DLL) and initialization (INI) files to a destination and registering the Component Object Model (COM) objects in creating the data security control. The second cabinet file can further comprise ActiveX™ control components in producing a scanning dialog box.

The method according to the invention can further comprise vulnerability assessment, detection and removal of defunct services as well as the step of giving notice to the client computer by the data security control if the amount of time between scans of the client computer exceeds a specific duration, or when the server is informed of a virus outbreak or when a new virus pattern file is released.

The network system according to a preferred embodiment of the invention includes a computer server having at least a first cabinet file and a second cabinet file, a client computer having at least an Internet browser connected with the server, and an data security control on the browser of the client computer wherein the browser is redirected to a specific web page for scanning computer viruses.

In a further embodiment according to the invention, the first cabinet file further comprises at least one dynamic link library (DLL) file, one initialization (INI) file, and one font information (INF) file. The dynamic link library (DLL) file further comprises data security control icons for the browser and Component Object Model (COM) objects. The initialization (INI) file further comprises Uniform Resource Locator (URL) information linking to the second cabinet file located on the server. The network system according to the invention wherein the font information (INF) file copies the dynamic link library (DLL) and initialization (INI) files to a destination and registers the Component Object Model (COM) objects creating the data security control. The second cabinet file further comprises control components producing a scanning dialog box. The network system according to the invention can further include a function where the data security control gives notice to the client computer if the amount of time between scans of the client computer exceeds a specific duration, or when the server is informed of a virus outbreak or when a new virus pattern file is released. Other functions performed by the data security control include vulnerability assessment of the client.

Another preferred embodiment according to the invention provides a data security platform for a client computer in a network system having a server. The browser platform further comprises an Internet browser provided at the client computer, a first cabinet file directed to the client computer from the server, a second cabinet file called from the client computer, an data security control provided at the browser, embedded control components causing the browser to pop up in producing a scanning dialog box wherein the client computer is scanned for computer viruses. The first cabinet file further comprises at least one dynamic link library (DLL) file, one initialization (INI) file, and one font information (INF) file. The dynamic link library (DLL) file further comprises data security control icons for the browser and Component Object Model (COM) objects. The initialization (INI) file further comprises Uniform Resource Locator (URL) information linking to the second cabinet file located on the server. The font information (INF) file copies the dynamic link library (DLL) and initialization (INI) files to a destination and registers the Component Object Model (COM) objects creating the data security control. The second cabinet file further comprises ActiveX™ control components producing a scanning dialog box. The data security control gives notice to said client computer if the amount of time between scans of the client computer exceeds a specific duration or when the server is informed of a virus outbreak or when a new virus pattern file is released. Other functions performed by the data security control include vulnerability assessment of the client computer services on the client computer.

### BRIEF DESCRIPTION OF THE DRAWINGS

The foregoing features and advantages of the invention will become more apparent in the following Detailed Description when read in conjunction with the accompanying drawings (not necessarily drawn to scale), in which:

FIG. 1 is a flow diagram illustrating a preferred embodiment of the process of an data security methodology integrated with an Internet browser according to the invention;

FIG. 2 is a flow diagram illustrating a preferred embodiment of the process of data security control according to the invention;

FIG. 3 is a schematic view illustrating an exemplary structure for the data security network system integrated with a browser platform according to the invention;

FIG. 4 is a schematic view illustrating an exemplary data structure for the data security network system integrated with a browser platform according to the invention; and

FIG. 5 is a diagram illustrating an exemplary view of the data security system having a browser platform according to a preferred embodiment of the invention.

### DETAILED DESCRIPTION OF PREFERRED EMBODIMENTS

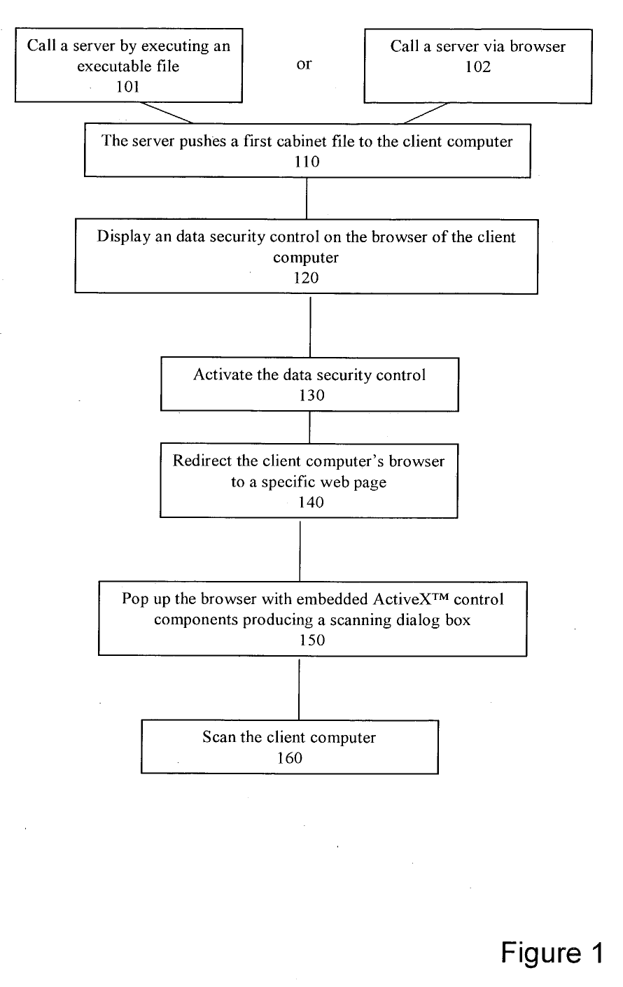

FIG. 1 is a flow diagram illustrating a preferred embodiment of the process of an data security methodology integrated with a browser according to the invention. In step 101, a client computer 21 calls a server 20 having at least a first cabinet file 201 and a second cabinet file 202 by executing an independent executable file (step 101) or, alternatively, in step 102, a client computer 21 calls a server 20 having at least a first cabinet file 201 and a second cabinet file 202 through the Internet browser 30 at the client computer 21.

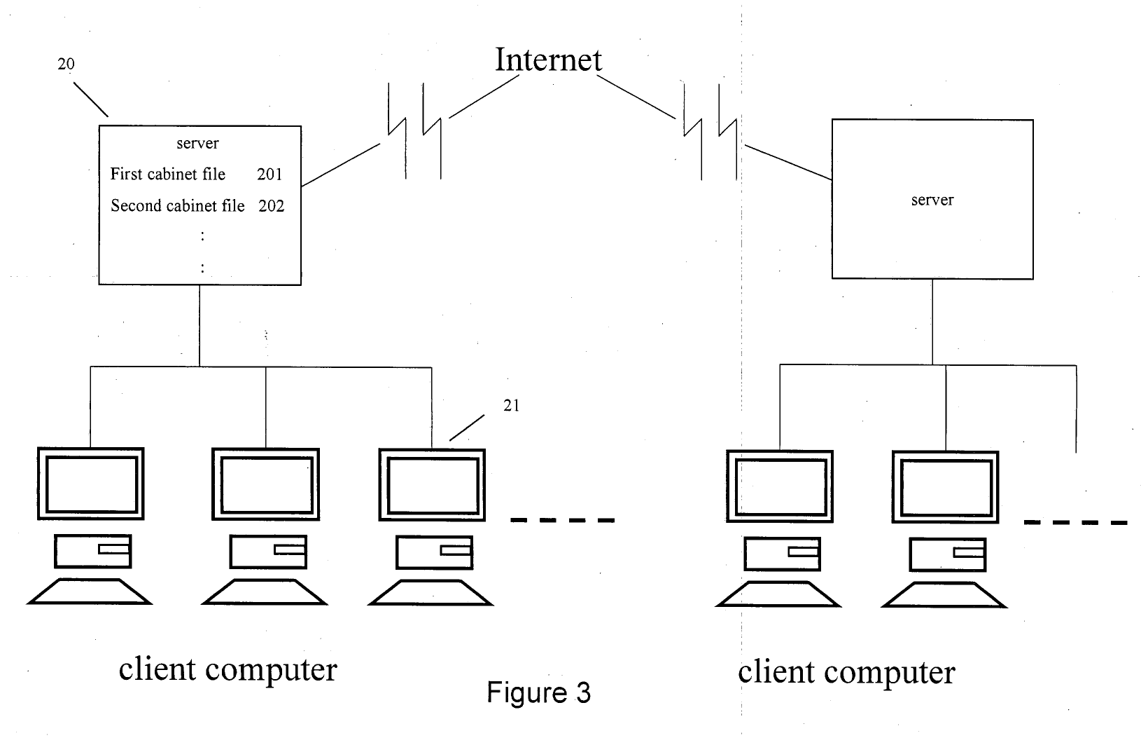

FIG. 3 is a schematic view that illustrates an exemplary structure for the data security network system integrated with a browser platform according to the invention. Referring to FIG. 3, the server 20 comprising at least a first cabinet file 201 and a second cabinet file 202 is connected with a client computer 21.

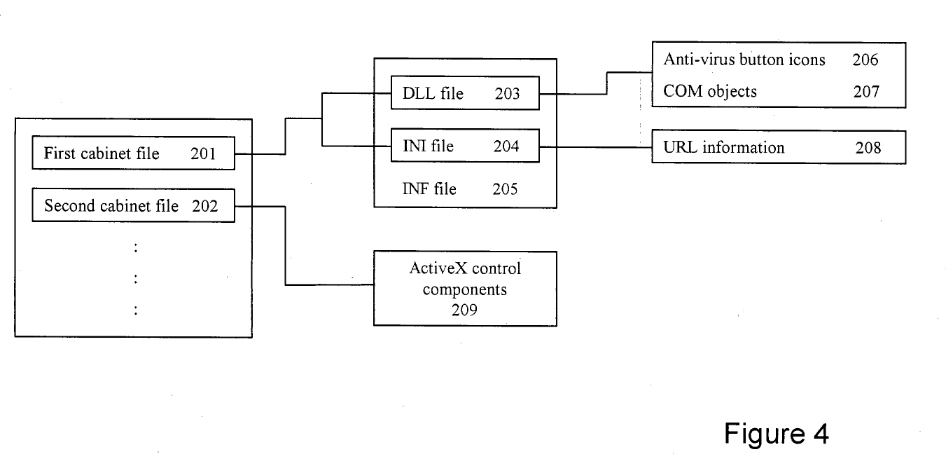

FIG. 4 is a schematic view illustrating an exemplary data structure for the data security network system integrated with a browser platform according to the invention. Referring to FIG. 4, the first cabinet file 201 further comprises at least one dynamic link library (DLL) file 203, one initialization (INI) file 204, and one font information (INF) file 205. A DLL file 203 is a library of executable functions or data that can be used by an application. Typically, a DLL file 203 provides one or more particular functions and a program accesses the functions by creating either a static or dynamic link to the DLL file 203. A static link generally remains constant during program execution while a dynamic link is created by the program as needed. A DLL file 203 can simply include data only. An INI file 204 is a file having configuration information for Microsoft Windows™. INI files, namely, WIN.INI and SYSTEM.INI, are required by Microsoft Windows™. In addition, other applications may have their own INI files. An INF file 205 contains information necessary for the creation of other files by font utilities.

The dynamic link library (DLL) file 203 further comprises data security control icons 206 for the browser 30 and Component Object Model (COM) objects 207. COM is a model for binary code developed by Microsoft Windows™. COM enables programmers to develop objects that can be accessed by any COM-compliant applications.

The initialization (INI) file 204 further comprises Uniform Resource Locator (URL) information 208 linking the second cabinet file 202 located on the server 20. An URL is the address of a file (resource) accessible on the Internet. The type of file or resource depends on the Internet application protocol. Using the World Wide Web's protocol, the Hypertext Transfer Protocol (HTTP), the resource can be Hypertext Markup Language (HTML) pages, an image file, a program such as a common gateway interface application or Java™ applet, or any other file supported by HTTP.

HTML stands for Hypertext Markup Language, which is the set of markup symbols or codes inserted in a file intended for display on a World Wide Web browser page. The markup tells the Web browser how to display a Web page's words and images for the user. Each individual markup code is referred to as an element or a tag. Some elements come in pairs that indicate when some display effect is to begin and when it is to end.

An applet is a small program that can be sent along with a Web page to a user. Java™ applets can perform interactive animations, immediate calculations, or other simple tasks without having to send a user request back to the server.

The URL contains the name of the protocol required to access the resource, a domain name that identifies a specific computer on the Internet, and a path name (hierarchical description of a file location) on the computer.

The font information (INF) file 205 copies the dynamic link library (DLL) 203 and initialization (INI) files 204 to a destination and registers the Component Object Model (COM) objects 207 in creating the data security control 301. The data security control 301 can further comprise a button or a toolbar or a scrollbar or an icon.

The second cabinet file 202 further comprises ActiveX™ control components 209 producing a scanning dialog box. The ActiveX™ is the name that Microsoft™ has given to a set of strategic object-oriented programming technologies and tools. The main technology is the COM used in a network with a directory and additional support, where COM becomes the distributed COM. A component is created when a program is written to run in the ActiveX™ environment, i.e., a self-sufficient program that can be run anywhere in the ActiveX™ network. This component is known as an ActiveX™ control. An ActiveX™ control is roughly equivalent to a Java™ applet.

In step 110, the server 20 directs the first cabinet file 201 to the client computer 21 and in step 120, the first cabinet file 201 displays a data security control 301 on the client computer's browser 30. After the installation is complete, in step 130, the data security control 301 is activated. In step 140, the browser 30 is redirected to a specific web page. In step 150, the browser 30 is popped up with embedded ActiveX™ control components 209 producing a scanning dialog box. In step 160, the client computer 21 is scanned for computer viruses. The methodology according to the invention, not only scans the client computer 21 but also surveys the status of the system.

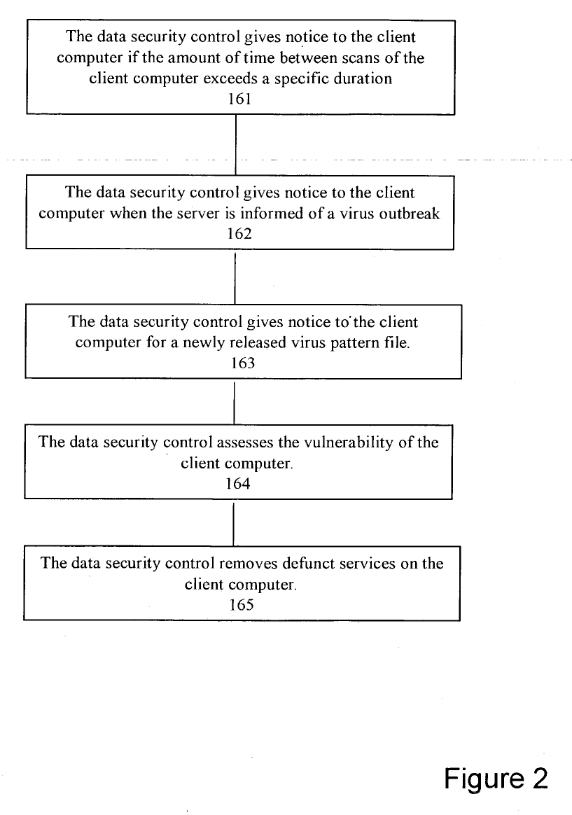

Moreover, notice is given to the client computer 21 in certain circumstances, in the form of, e.g., illuminating icons or sending emails or displaying warning messages or providing vocal warnings. FIG. 2 is a flow diagram illustrating a preferred embodiment of the process of data security control according to the invention. Referring to FIG. 2, in step 161, the data security control 301 gives notice to the client computer 21 if the amount of time between scans of the client computer 21 exceeds a specific duration. In step 162, the data security control 301 gives notice to the client computer 21 when the server 20 is informed of a virus outbreak. In step 163, the data security control 301 gives notice to the client computer 21 when a new virus pattern file is released. In step 164, the data security control 301 assesses the vulnerability of the client computer 21. In step 165, the data security control 301 removes defunct services on the client computer 21.

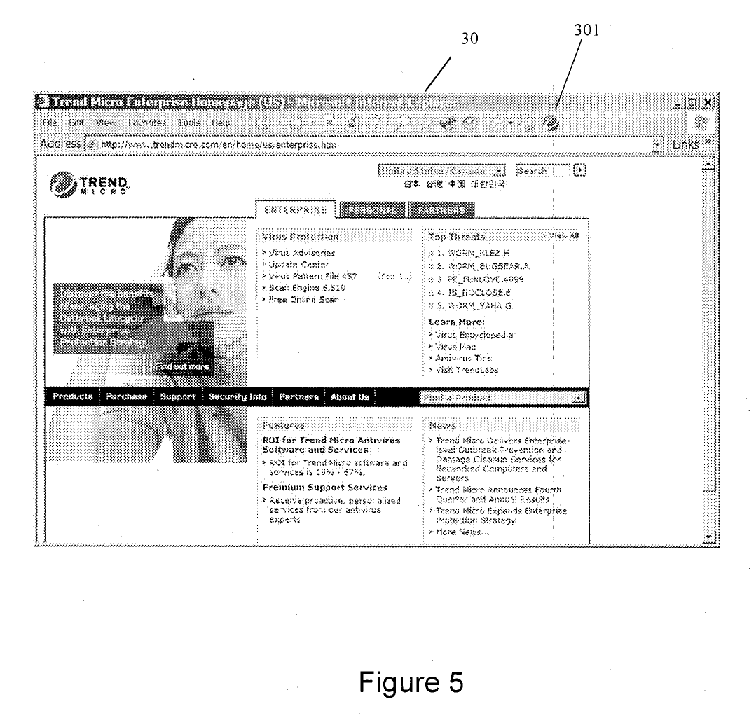

Another preferred embodiment according to the invention provides data security platform for a client computer 21 in a network system having a server 20. FIG. 5 is a diagram illustrating an exemplary view of the data security system having a browser platform according to a preferred embodiment of the invention. Referring to FIG. 5, the data security control 301 is advantageously integrated with the Internet browser 30 at the client computer 21. The data security control 301 can further comprise a button or a toolbar or a scrollbar or an icon.

The browser platform further comprises an Internet browser 30 provided at the client computer 21, a first cabinet file 201 directed to the client computer 21 from the server 20, a second cabinet file 202 called from the client computer 21, a data security control 301 provided at the browser 30, and embedded control components causing the browser 30 to pop up in producing a scanning dialog box wherein the client computer 21 is scanned for computer viruses. The first cabinet file 201 further comprises at least one dynamic link library (DLL) file 203, one initialization (INI) file 204, and one font information (INF) file 204. The dynamic link library (DLL) file 203 further comprises data security control icons 206 for the browser 30 and Component Object Model (COM) objects 207. The initialization (INI) file 204 further comprises Uniform Resource Locator (URL) information 208 linking to the second cabinet file 202 located on the server 20. The font information (INF) file 205 copies the dynamic link library (DLL) 203 and initialization (INI) files 204 to a destination and registers the Component Object Model (COM) objects 207 creating the data security control 301. The data security control 301 can further comprise a button or a toolbar or a scrollbar or an icon. The second cabinet file 202 further comprises ActiveX™ control components 209 producing a scanning dialog box. The data security control 301 gives notice to the client computer 21 if the amount of time between scans of the client computer 21 exceeds a specific duration or when the server 20 is informed of a virus outbreak or when a new virus pattern file is released. The step of giving notice to the client computer 21 can further comprise the step of illuminating icons or sending emails or displaying warning messages or providing vocal warning.

The data security control 301 could also act as a constant reminder of service and enhances company branding as an information channel to customers. The data security control 301 enables alerts for new computer virus patterns and program updates and sustains communications with customers between scans. The data security control 301 assesses the vulnerability of the client computer 21. The vulnerability assessment functionality further comprises the steps of detecting known vulnerabilities powered by the third-party Vulnerability Assessment (VA) scanner, reporting and implementing risk assessment of virus vulnerabilities through reports, periodic notifications and emergency alerts, providing prioritized virus vulnerability information with severity and probability scores, reporting automated, scheduled auditing results, remediation and optimization recommendations during periodic audits and during outbreaks, and deploying auto-updates and auto-fix capabilities.

One-click usage is easy to use and multi-featured services could be integrated into the data security control 301 such as pay security services model and product promotions. The functions of the data security control 301 are extendable and thus fit future needs in scalability. The browser level is closer to the users, and from the commercial point of view, a data security method integrated with a browser will bring numerous benefits and advantages such as expanding customer base, limited annoyance, reminder of service, extension to other services, and communication with customers.

It would be apparent to one skilled in the art that the invention can be embodied in various ways and implemented in many variations. The invention is accordingly applicable in this and other types of networks using browsers, such as a metropolitan area network (MAN), a wide area network (WAN), a local area network (LAN) or even wireless communications networks for mobile phones and personal digital assistant (PDA) devices. Such variations are not to be regarded as a departure from the spirit and scope of the invention. In particular, the process steps of the method according to the invention will include methods having substantially the same process steps as the method of the invention to achieve substantially the same results. Substitutions and modifications have been suggested in the foregoing Detailed Description, and others will occur to one of ordinary skill in the art. All such modifications as would be obvious to one skilled in the art are intended to be included within the scope of the following claims and their equivalents.

We claim:

1. A data security method integrated with a browser platform, the method comprising the steps of:
(a) calling a server having at least a first cabinet file and a second cabinet file from a client computer;
(b) directing said first cabinet file to said client computer by said server;
(c) displaying a data security control on a browser at said client computer;
(d) activating said data security control;
(e) redirecting said browser at said client computer to a specific web page;
(f) popping up said browser with embedded control components producing a scanning dialog box; and
(g) scanning said client computer for computer viruses.

2. The method of claim 1 further comprising the step of executing an independent executable file.

3. The method of claim 1 further comprising the step of calling said server through said client computer.

4. The method of claim 1 wherein said first cabinet file further comprises at least one dynamic link library (DLL) file, one initialization (INI) file, and one font information (INF) file.

5. The method of claim 4 wherein said dynamic link library (DLL) file further comprises data security control icons for said browser and Component Object Model (COM) objects.

6. The method of claim 4 wherein said initialization (INI) file further comprises Uniform Resource Locator (URL) information linking said second cabinet file located on said server.

7. The method of claim 4 wherein said font information (INF) file copies the dynamic link library (DLL) and initialization (INI) files to a destination and registers the Component Object Model (COM) objects creating the data security control.

8. The method of claim 1 wherein said second cabinet file further comprises ActiveX™ control components producing a scanning dialog box.

9. The method of claim 1 further comprising the step of giving notice to said client computer by said data security control if the amount of time between scans of the client computer exceeds a specific duration.

10. The method of claim 1 further comprising the step of giving notice to said client computer by said data security control when the server is informed of a virus outbreak.

11. The method of claim 1 further comprising the step of giving notice to said client computer by said data security control when a new virus pattern file is released.

12. The method of claim 1 further comprising the step of vulnerability assessment of said client computer by said data security control.

13. A network system comprising:
a server having at least a first cabinet file and a second cabinet file;
a client computer having at least a browser connected with said server;
a data security control on said browser of said client computer;
wherein said browser is redirected to a specific web page for scanning computer viruses.

14. The network system of claim 13 wherein said first cabinet file further comprises at least one dynamic link library (DLL) file, one initialization (INI) file, and one font information (INF) file.

15. The network system of claim 14 wherein said dynamic link library (DLL) file further comprises said data security control icons for said browser and Component Object Model (COM) objects.

16. The network system of claim 14 wherein said initialization (INI) file further comprises Uniform Resource Locator (URL) information linking to said second cabinet file located on said server.

17. The network system of claim 14 wherein said font information (INF) file copies said dynamic link library (DLL) and initialization (INI) files to a destination and registers said Component Object Model (COM) objects creating said data security control.

18. The network system of claim 13 wherein said second cabinet file further comprises ActiveX™ control components producing a scanning dialog box.

19. The network system of claim 13 wherein said data security control gives notice to said client computer if the amount of time between scans of the client computer exceeds a specific duration.

20. The network system of claim 13 wherein said data security control gives notice to said client computer when said server is informed of a virus outbreak.

21. The network system of claim 13 wherein said data security control gives notice to said client computer when a new virus pattern file is released.

22. The network system of claim 13 wherein said data security control assesses vulnerability of said client computer.

23. An data security browser platform for a client computer in a network system having a server, the browser platform further comprising:
an Internet browser provided at said client computer;
a first cabinet file directed to said client computer from said server;
a second cabinet file called from said client computer;
a data security control provided at said browser; and
embedded control components causing said browser to pop up in producing a scanning dialog box wherein said client computer is scanned for computer viruses.

24. The data security browser platform of claim 23 wherein said first cabinet file further comprises at least one dynamic link library (DLL) file, one initialization (INI) file, and one font information (INF) file.

25. The data security browser platform of claim 24 wherein said dynamic link library (DLL) file further comprises data security control icons for said browser and Component Object Model (COM) objects.

26. The data security browser platform of claim 24 wherein said initialization (INI) file further comprises Uniform Resource Locator (URL) information linking to said second cabinet file located on said server.

27. The data security browser platform of claim 24 wherein said font information (INF) file copies the dynamic link library (DLL) and initialization (INI) files to a destination and registers the Component Object Model (COM) objects creating the data security control.

28. The data security browser platform of claim 23 wherein said second cabinet file further comprises ActiveX™ control components producing a scanning dialog box.

29. The data security browser platform of claim 23 wherein said data security control gives notice to said client computer if the amount of time between scans of the said client computer exceeds a specific duration.

30. The data security browser platform of claim 23 wherein said data security control gives notice to said client computer when said server is informed of a virus outbreak.

31. The data security browser platform of claim 23 wherein said data security control gives notice to said client computer when a new virus pattern file is released.

32. The data security browser platform of claim 23 wherein said data security control assesses vulnerability of said client computer.

33. The data security browser platform of claim 23 wherein said data security control removes defunct services on said client computer.
